(19) United States
(12) Patent Application Publication
(10) Pub. No.: US 2023/0373412 A1
(43) Pub. Date: Nov. 23, 2023

(54) PROTECTOR

(71) Applicant: Yazaki Corporation, Tokyo (JP)

(72) Inventor: Youngho JANG, Aichi (JP)

(73) Assignee: Yazaki Corporation, Tokyo (JP)

(21) Appl. No.: 18/317,278

(22) Filed: May 15, 2023

(30) Foreign Application Priority Data
May 17, 2022 (JP) 2022-080758

(51) Int. Cl. B60R 16/02

(52) U.S. Cl. CPC B60R 16/0215

(57) ABSTRACT

A protector includes: a base that is configured to accommodate a wire harness; and a cover that is connected to the base to cover the base. At least one of the base and the cover is provided with an elastic piece that is arranged to extend in a direction intersecting with an extension direction of the wire harness, and that abuts on the wire harness.

### CROSS-REFERENCE TO RELATED APPLICATION

The present application is based on, and claims priority from the prior Japanese Patent Application No. 2022-080758, filed on May 17, 2022, the entire contents of which are incorporated herein by reference.

### TECHNICAL FIELD

The present disclosure relates to a protector.

### BACKGROUND

Inside a vehicle such as a motor vehicle, a number of wire harnesses that bundle a plurality of wires are arranged, and in some cases a protector is mounted on such wire harnesses to protect the wires. The protector is provided with a base that accommodates the wire harnesses, and a cover that is connected to the base to cover the base (see JP 2015-53804 A, for example).

### SUMMARY

In the protector disclosed in JP 2015-53804 A, since a vibration absorber made of an elastic member is provided between the base and the cover, it is possible to suppress the wire harness from moving in the protector and generating noise. However, since the protector is mounted on wire harnesses having various outer diameters, a gap may occur between a wire harness and the vibration absorber depending on the outer diameter of the wire harness, and the wire harness may move in the protector and cause abnormal noise. It is possible to prevent the wire harness from moving in the protector by adjusting the outer diameter of the wire harness by wrapping a tape or the like around the outer diameter of the wire harness; however, this method is not preferable in terms of manufacturing costs.

An object of the present disclosure is to provide a protector that is advantageous in suppressing the generation of abnormal noise by holding a wire harness.

A protector according to an embodiment includes: a base that is configured to accommodate a wire harness; and a cover that is connected to the base to cover the base. At least one of the base and the cover is provided with an elastic piece that is arranged to extend in a direction intersecting with an extension direction of the wire harness, and that abuts on the wire harness.

The above configuration makes it possible to provide a protector that is advantageous in suppressing the generation of abnormal noise by holding a wire harness.

### BRIEF DESCRIPTION OF THE DRAWINGS

FIG. 1 is a perspective view of a main portion of a protector according to a first embodiment as an example.

FIG. 2 is a front view of the main portion of the protector according to the first embodiment.

FIG. 3 is a front view of the exploded main portion of the protector according to the first embodiment.

FIG. 4 is a plan view of the main portion of the protector according to the first embodiment.

FIG. 5 is a bottom view of the main portion of the protector according to the first embodiment.

FIG. 6 is a perspective view of a main portion of a protector according to a second embodiment as an example.

FIG. 7 is a front view of the main portion of the protector according to the second embodiment.

FIG. 8 is a front view of the exploded main portion of the protector according to the second embodiment.

FIG. 9 is a plan view of the main portion of the protector according to the second embodiment.

FIG. 10 is a bottom view of the main portion of the protector according to the second embodiment.

FIG. 11 is a perspective view of a main portion of a protector according to a third embodiment as an example.

FIG. 12 is a front view of the main portion of the protector according to the third embodiment.

FIG. 13 is a front view of the exploded main portion of the protector according to the third embodiment.

FIG. 14 is a plan view of the main portion of the protector according to the third embodiment.

FIG. 15 is a bottom view of the main portion of the protector according to the third embodiment.

FIG. 16 is a perspective view of a main portion of a protector according to a fourth embodiment as an example.

FIG. 17 is a front view of the main portion of the protector according to the fourth embodiment.

FIG. 18 is a front view of the exploded main portion of the protector according to the fourth embodiment.

FIG. 19 is a plan view of the main portion of the protector according to the fourth embodiment.

FIG. 20 is a bottom view of the main portion of the protector according to the fourth embodiment.

FIG. 21 is a perspective view of a main portion of a protector according to a fifth embodiment as an example.

FIG. 22 is a front view of the main portion of the protector according to the fifth embodiment.

FIG. 23 is a front view of the exploded main portion of the protector according to the fifth embodiment.

FIG. 24 is a plan view of the main portion of the protector according to the fifth embodiment.

FIG. 25 is a bottom view of the main portion of the protector according to the fifth embodiment.

### DETAILED DESCRIPTION

Various embodiments will be described hereinafter with reference to the accompanying drawings.

### First Embodiment

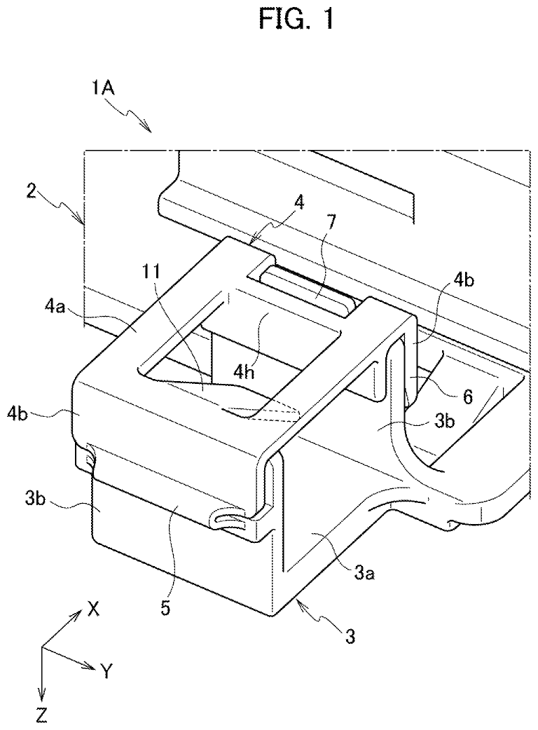

FIG. 1 is a perspective view of a main portion of a protector 1A according to a first embodiment.

The protector 1A holds a wire harness 100 that is installed in a vehicle such as a motor vehicle and routed inside the vehicle. The wire harness 100 is formed of a bundle of wires. The shape or structure of the wire harness 100 to be held by the protector 1A is not particularly limited. In the following figures, the wire harness 100 is illustrated schematically as a two-dot chain line.

The protector 1A has a protector body 2 fixed to a panel such as a body panel (not illustrated) inside the vehicle. The material of the protector body 2 is, for example, a synthetic resin material.

The protector 1A is supported by a panel (not illustrated). For this reason, in the following figures, the up-down direction in which the protector 1A is installed on the panel is defined as the Z direction. In addition, two directions perpendicular to each other in virtual planes perpendicular to the Z direction are defined as the X direction and the Y direction. Of these directions, the Y direction is along the extension direction when the wire harness 100 is attached.

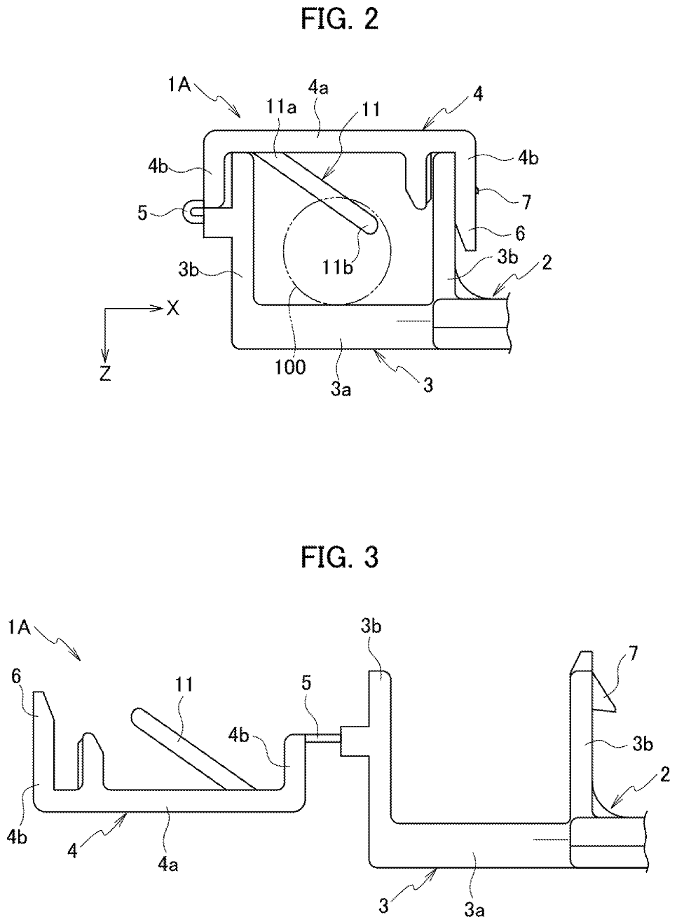

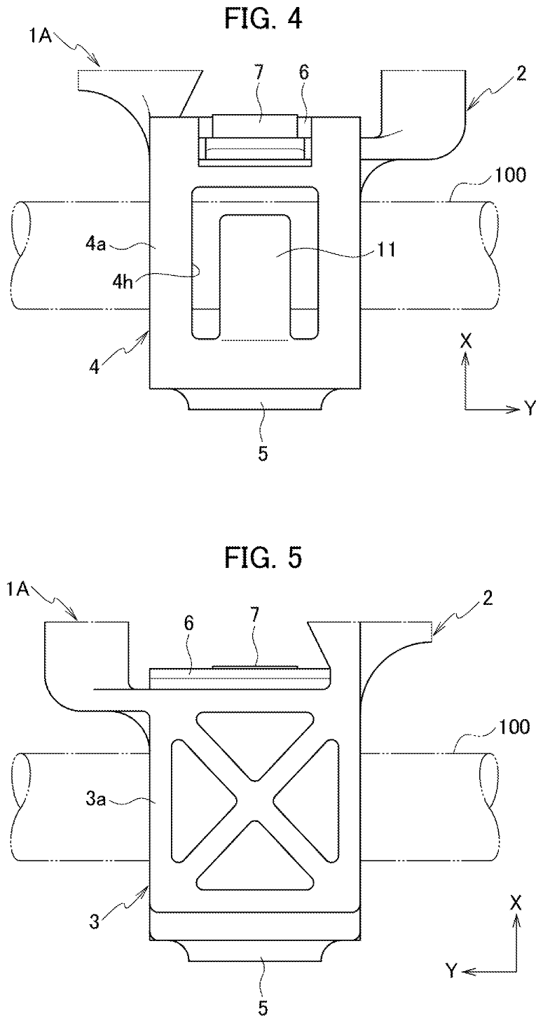

FIG. 2 is a front view of the main portion of the protector 1A according to the first embodiment, and FIG. 3 is a front view of the exploded main portion of the protector 1A according to the first embodiment. The protector 1A illustrated in FIG. 3 is in a state before the wire harness 100 is held. In addition, FIG. 4 is a plan view of the main portion of the protector 1A according to the first embodiment, and FIG. 5 is a bottom view of the main portion of the protector 1A according to the first embodiment.

The protector body 2 includes a base 3 and a cover 4.

The base 3 accommodates the wire harness 100. The base 3 is formed in a U-shape in cross section, and has a bottom wall 3a and a pair of lower side walls 3b and 3b. The cover 4 is connected to one of the pair of lower side walls 3b and 3b of the base 3 via a hinge 5, and a hook 7 is formed on the other of the pair of lower side walls 3b and 3b and is locked to a locking part 6 of the cover 4.

The cover 4 is connected to the base 3 to cover the base 3. The cover 4 is formed in an inverted U-shape in cross section, and has a top wall 4a and a pair of upper side walls 4b and 4b. The base 3 is connected to one of the pair of upper side walls 4b and 4b of the cover 4 via the hinge 5, and the locking part 6 is formed on the other of the pair of upper side walls 4b and 4b. The hook 7 of the base 3 is locked to the locking part 6.

The cover 4 is mounted on the base 3 by covering the opening side of the base 3 with the cover 4 and locking the hook 7 to the locking part 6.

The cover 4 includes an elastic piece 11 that is arranged to extend in a direction (in the present embodiment, X direction) intersecting with the extension direction of the wire harness 100 (Y direction), and that abuts on the wire harness 100. In consideration of the formability of the mold, a through-hole (first through-hole 4h) is provided in the top wall 4a that is the portion of the cover 4 that faces the bottom wall 3a, and the elastic piece 11 extends from the periphery of the first through-hole 4h.

The elastic piece 11 of the cover 4 has one end 11a as a fixed end and the other end 11b as a free end. That is, the elastic piece 11 is cantilevered with respect to the cover 4. The elastic piece 11 has a fixed end arranged on one side in the X direction (left side in FIG. 2), and a free end arranged on the other side in the X direction (right side in FIG. 2).

In the present embodiment, the elastic piece 11 is provided in the cover 4 but the present embodiment is not limited thereto. The elastic piece 11 may be provided in the base 3.

Next, the operation of the protector 1A will be described below.

First, the wire harness 100 is accommodated in the base 3, and the cover 4 is mounted on the opening side of the base 3.

When the cover 4 is mounted on the base 3, the elastic piece 11 is deformed according to the outer diameter of the wire harness 100, and the wire harness 100 is held using the reaction force, thereby making it possible to suppress the wire harness 100 from moving in the protector 1A.

Next, the effect of the protector 1A will be described.

The protector 1A according to the present embodiment includes: the base 3 that is configured to accommodate the wire harness 100; and the cover 4 that is connected to the base 3 to cover the base 3. At least one of the base 3 and the cover 4 is provided with the elastic piece 11 that is arranged to extend in a direction (X direction) intersecting with the extension direction of the wire harness 100 (Y direction), and that abuts on the wire harness 100.

According to the protector 1A of the present embodiment, by providing the elastic piece 11 on at least one of the base 3 and the cover 4, the elastic piece 11 is deformed according to the outer diameter of the wire harness 100, thereby making it possible to hold the wire harness 100 using the reaction force. For this reason, regardless of the outer diameter of the wire harness 100 arranged in the protector 1A, it is possible to suppress the wire harness 100 from moving in the protector 1A and generating abnormal noise.

As described above, the present embodiment makes it possible to provide the protector 1A that is advantageous in suppressing the generation of abnormal noise by holding the wire harness 100.

In the protector 1A according to the present embodiment, the elastic piece 11 has one end 11a as a fixed end and the other end 11b as a free end.

Further, in the protector 1A according to the present embodiment, the elastic piece 11 has a fixed end arranged on one side in a direction (X direction) intersecting with the extension direction of the wire harness 100 (Y direction). In addition, the elastic piece 11 has a free end arranged on the other side in the direction (X direction) intersecting with the extension direction of the wire harness 100 (Y direction).

By forming the elastic piece 11 in this way, when the cover 4 is mounted on the base 3, the elastic piece 11 is deformed according to the outer diameter of the wire harness 100, thereby making it possible to hold the wire harness 100 using the reaction force.

### Second Embodiment

Next, a protector 1B according to a second embodiment will be described. It should be noted that components that are substantially the same as those of the above protector 1A are denoted by the same reference numerals, and a description thereof will be omitted.

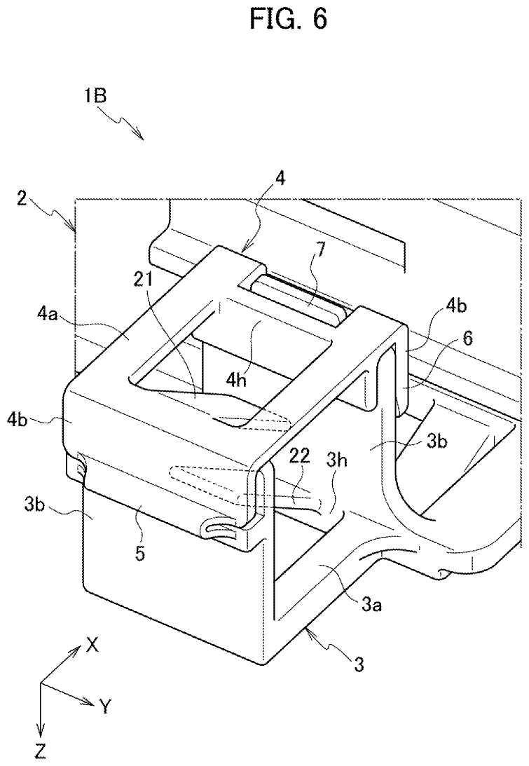

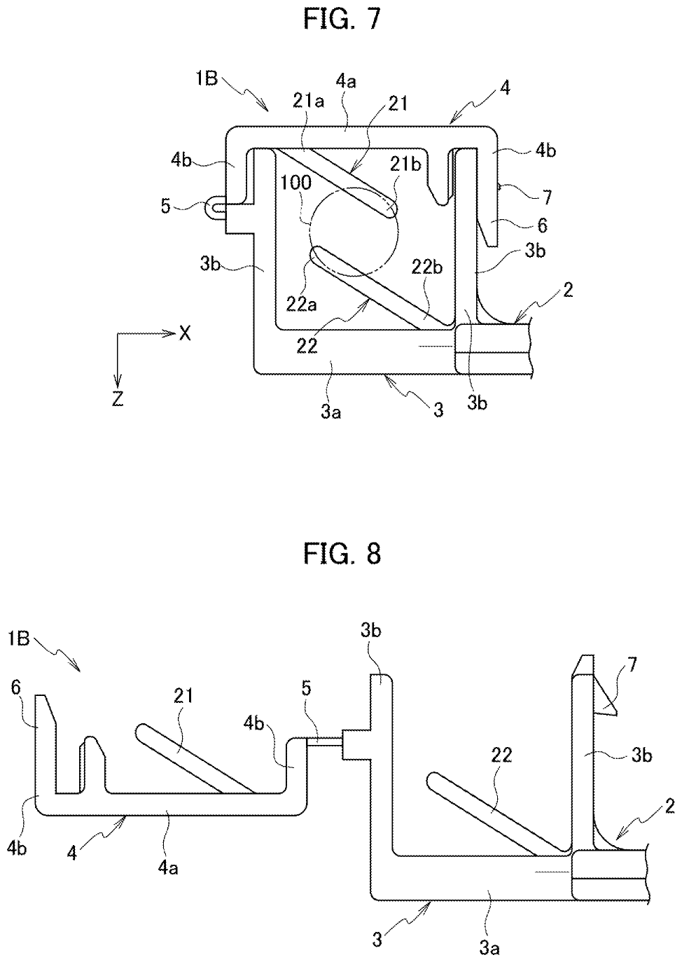

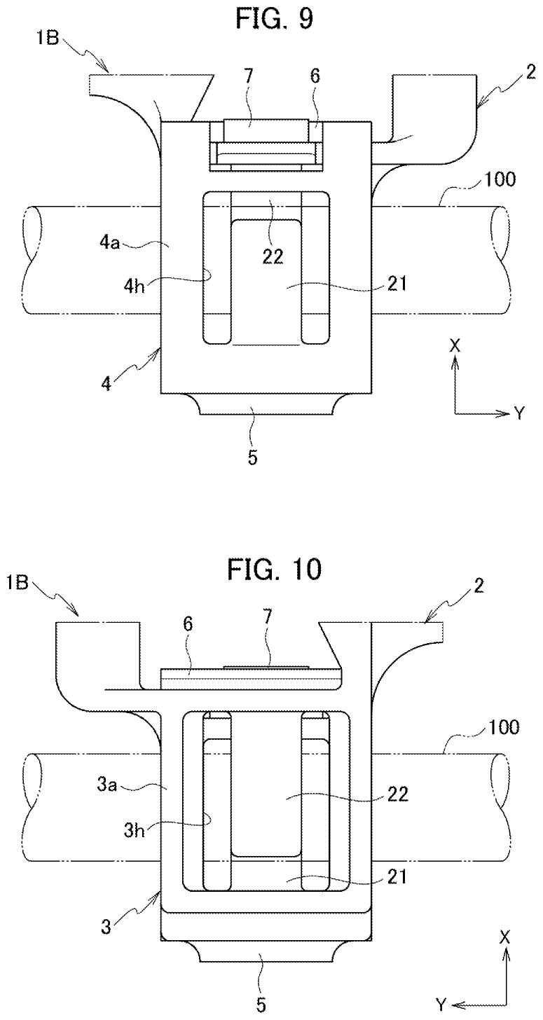

FIG. 6 is a perspective view of the main portion of the protector 1B according to the second embodiment. FIG. 7 is a front view of the main portion of the protector 1B according to the second embodiment, and FIG. 8 is a front view of the exploded main portion of the protector 1B according to the second embodiment. The protector 1B illustrated in FIG. 8 is in a state before the wire harness 100 is held. In addition, FIG. 9 is a plan view of the main portion of the protector 1B according to the second embodiment, and FIG. 10 is a bottom view of the main portion of the protector 1B according to the second embodiment.

The cover 4 includes a first elastic piece 21 that is arranged to extend in a direction (X direction) intersecting with the extension direction of the wire harness 100 (Y direction), and that abuts on the wire harness 100. In consideration of the formability of the mold, a first through-hole 4h is provided in the top wall 4a that is the portion of the cover 4 that faces the bottom wall 3a, and the first elastic piece 21 extends from the periphery of the first through-hole 4h.

The first elastic piece 21 has one end 21a as a fixed end and the other end 21b as a free end. That is, the elastic piece 21 is cantilevered with respect to the cover 4. The elastic piece 21 has a fixed end arranged on one side in the X direction (left side in FIG. 7), and a free end arranged on the other side in the X direction (right side in FIG. 7).

The base 3 includes a second elastic piece 22 that is arranged to extend in the X direction, and that abuts on the wire harness 100 from the side opposite to the first elastic piece 21. In consideration of the formability of the mold, a second through-hole 3h is provided in the bottom wall 3a that is the portion of the base 3 that faces the top wall 4a, and the second elastic piece 22 extends from the periphery of the second through-hole 3h.

The elastic second piece 22 has one end 22b as a fixed end and the other end 22a as a free end. That is, the elastic second piece 22 is cantilevered with respect to the base 3. The elastic second piece 22 has a free end arranged on one side in the X direction (left side in FIG. 7), and a fixed end arranged on the other side in the X direction (right side in FIG. 7).

Next, the effect of the protector 1B will be described.

In the protector 1B according to the second embodiment, the elastic piece includes the first elastic piece 21 that is provided in the cover 4 so as to extend in a direction (X direction) intersecting with the extension direction of the wire harness 100 (Y direction), and that abuts on the wire harness 100. The elastic piece includes the second elastic piece 22 that is provided in the base 3 so as to extend in the direction (X direction) intersecting with the extension direction of the wire harness 100 (Y direction), and that abuts on the wire harness 100 from the side opposite to the first elastic piece 21.

In the protector 1B according to the second embodiment, the first elastic piece 21 and the second elastic piece 22 each have one end 21a and 22b as a fixed end and the other end 21b and 22a as a free end.

Further, in the protector 1B according to the second embodiment, the first elastic piece 21 has a fixed end arranged on one side in a direction (X direction) intersecting with the extension direction of the wire harness 100 (Y direction), and a free end arranged on the other side in the intersecting direction (X direction). The second elastic piece 22 has a free end arranged on one side in the direction (X direction) intersecting with the extension direction of the wire harness 100 (Y direction), and a fixed end arranged on the other side in the intersecting direction (X direction).

By forming the first elastic piece 21 and the second elastic piece 22 in this way, when the cover 4 is mounted on the base 3, the first elastic piece 21 and the second elastic piece 22 are deformed according to the outer diameter of the wire harness 100, thereby making it possible to hold the wire harness 100 using the reaction force.

As described above, as in the first embodiment, the second embodiment makes it possible to provide the protector 1B that is advantageous in suppressing the generation of abnormal noise by holding the wire harness 100.

### Third Embodiment

Next, a protector 1C according to a third embodiment will be described. It should be noted that components that are substantially the same as those of the above protectors are denoted by the same reference numerals, and a description thereof will be omitted.

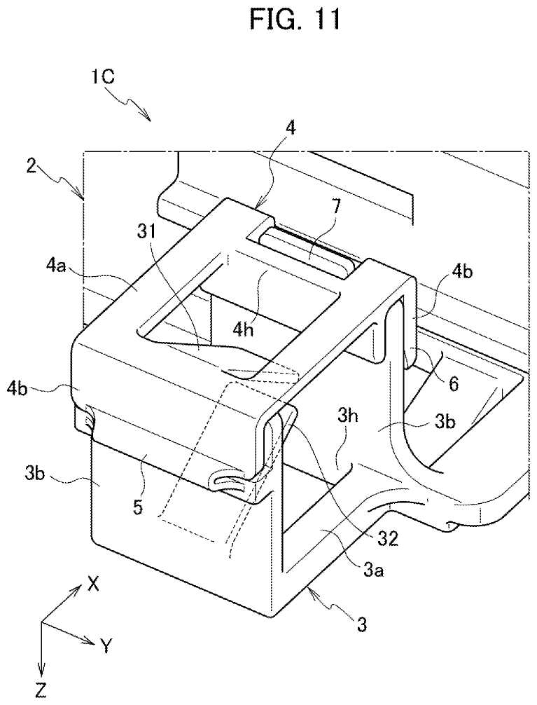

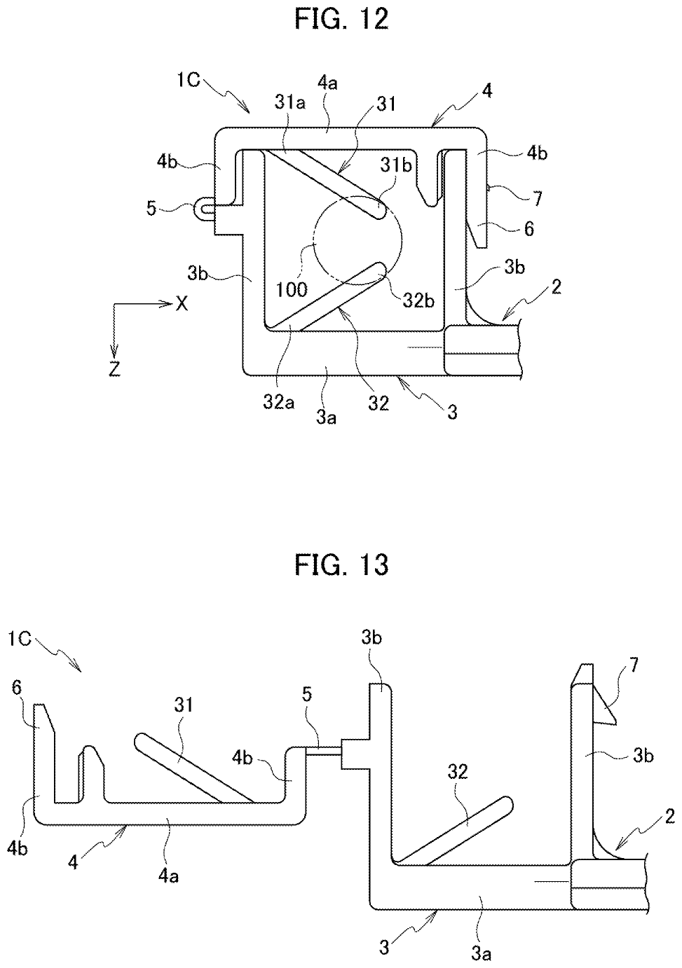

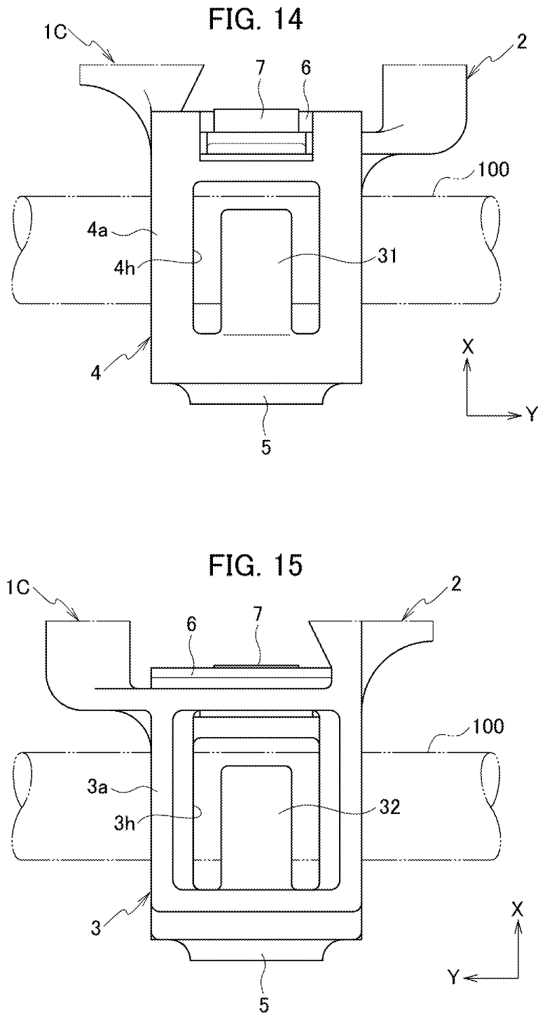

FIG. 11 is a perspective view of the main portion of the protector 1C according to the third embodiment. FIG. 12 is a front view of the main portion of the protector 1C according to the third embodiment, and FIG. 13 is a front view of the exploded main portion of the protector 1C according to the third embodiment. The protector 1C illustrated in FIG. 13 is in a state before the wire harness 100 is held. In addition, FIG. 14 is a plan view of the main portion of the protector 1C according to the third embodiment, and FIG. 15 is a bottom view of the main portion of the protector 1C according to the third embodiment.

The cover 4 includes a first elastic piece 31 that is arranged to extend in a direction (X direction) intersecting with the extension direction of the wire harness 100 (Y direction), and that abuts on the wire harness 100. In consideration of the formability of the mold, a first through-hole 4h is provided in the top wall 4a that is the portion of the cover 4 that faces the bottom wall 3a, and the first elastic piece 31 extends from the periphery of the first through-hole 4h.

The first elastic piece 31 has one end 31a as a fixed end and the other end 31b as a free end. That is, the first elastic piece 31 is cantilevered with respect to the cover 4. The first elastic piece 31 has a fixed end arranged on one side in the X direction (left side in FIG. 12), and a free end arranged on the other side in the X direction (right side in FIG. 12).

The base 3 includes a second elastic piece 32 that is arranged to extend in the X direction, and that abuts on the wire harness 100 from the side opposite to the first elastic piece 31. In consideration of the formability of the mold, a second through-hole 3h is provided in the bottom wall 3a that is the portion of the base 3 that faces the top wall 4a, and the second elastic piece 32 extends from the periphery of the second through-hole 3h.

The elastic second piece 32 has one end 32a as a fixed end and the other end 32b as a free end. That is, the elastic second piece 32 is cantilevered with respect to the base 3. The elastic second piece 32 has a fixed end arranged on one side in the X direction (left side in FIG. 12), and a free end arranged on the other side in the X direction (right side in FIG. 12).

Next, the effect of the protector 1C will be described.

In the protector 1C according to the third embodiment, the elastic piece includes the first elastic piece 31 that is provided in the cover 4 so as to extend in a direction (X direction) intersecting with the extension direction of the wire harness 100 (Y direction), and that abuts on the wire harness 100. The elastic piece includes the second elastic piece 32 that is provided in the base 3 so as to extend in the direction (X direction) intersecting with the extension direction of the wire harness 100 (Y direction), and that abuts on the wire harness 100 from the side opposite to the first elastic piece 31.

In the protector 1C according to the third embodiment, the first elastic piece 31 and the second elastic piece 32 each have one end 31a and 32a as a fixed end and the other end 31b and 32b as a free end.

Further, in the protector 1C according to the third embodiment, the first elastic piece 31 and the second elastic piece 32 have fixed ends arranged on one side in the direction (X direction) intersecting with the extension direction of the wire harness 100 (Y direction), and free ends arranged on the other side in the intersecting direction (X direction).

By forming the first elastic piece 31 and the second elastic piece 32 in this way, when the cover 4 is mounted on the base 3, the first elastic piece 31 and the second elastic piece 32 are deformed according to the outer diameter of the wire harness 100, thereby making it possible to hold the wire harness 100 using the reaction force.

As described above, as in the first and second embodiments, the third embodiment makes it possible to provide the protector 1C that is advantageous in suppressing the generation of abnormal noise by holding the wire harness 100.

### Fourth Embodiment

Next, a protector 1D according to a fourth embodiment will be described. It should be noted that components that are substantially the same as those of the above protectors are denoted by the same reference numerals, and a description thereof will be omitted.

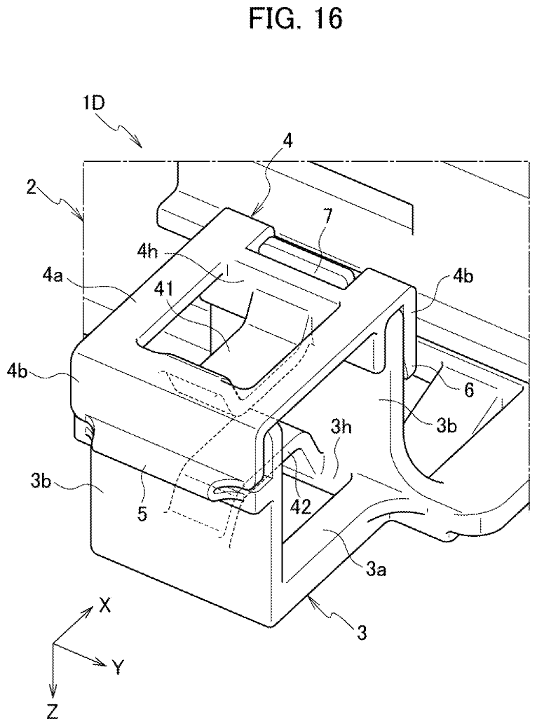

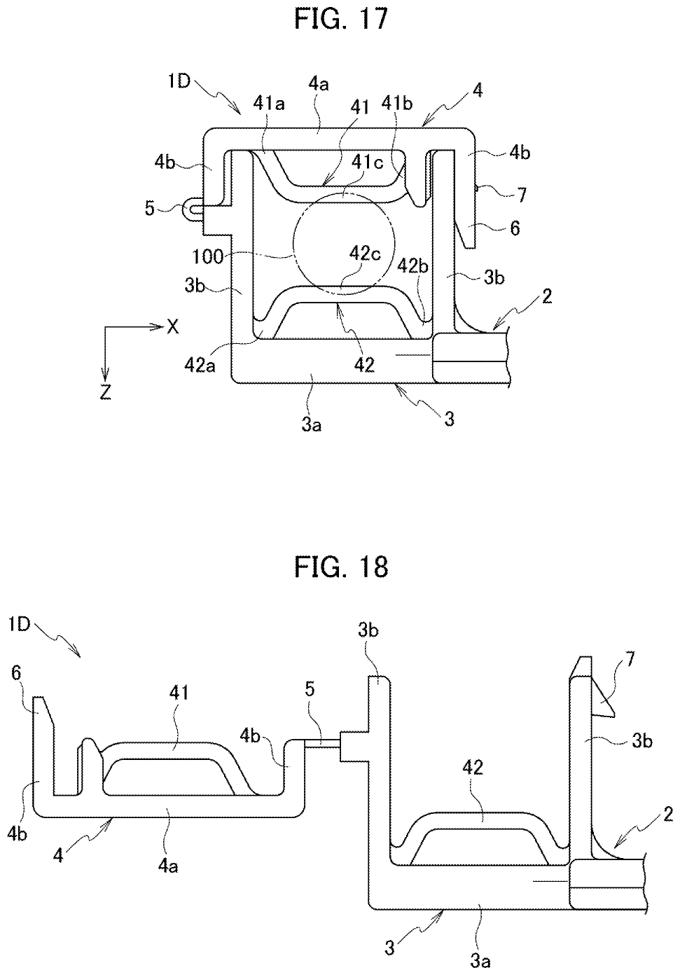

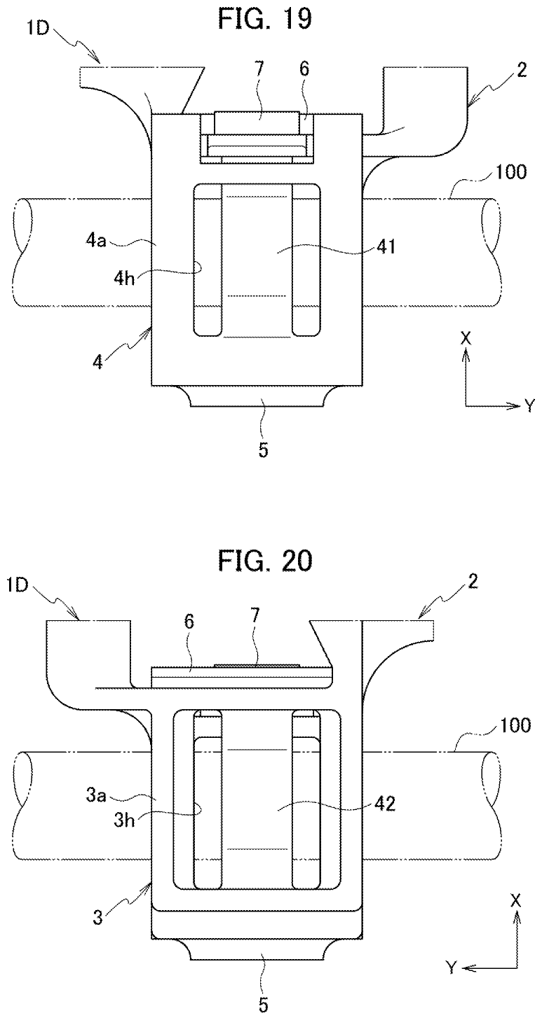

FIG. 16 is a perspective view of the main portion of the protector 1D according to the fourth embodiment. FIG. 17 is a front view of the main portion of the protector 1D according to the fourth embodiment, and FIG. 18 is a front view of the exploded main portion of the protector 1D according to the fourth embodiment. The protector 1D illustrated in FIG. 18 is in a state before the wire harness 100 is held. In addition, FIG. 19 is a plan view of the main portion of the protector 1D according to the fourth embodiment, and FIG. 20 is a bottom view of the main portion of the protector 1D according to the fourth embodiment.

The cover 4 includes a first elastic piece 41 that is arranged to extend in a direction (X direction) intersecting with the extension direction of the wire harness 100 (Y direction), and that abuts on the wire harness 100. In consideration of the formability of the mold, a first through-hole 4h is provided in the top wall 4a that is the portion of the cover 4 that faces the bottom wall 3a, and the first elastic piece 41 extends from the periphery of the first through-hole 4h.

The first elastic piece 41 has both ends 41a and 41b in the X direction as fixed ends. That is, the first elastic piece 41 is supported at both ends with respect to the cover 4. In addition, the first elastic piece 41 has a first curved part 41c having a shape in which the portion between both ends 41a and 41b in the X direction is curved to be convex toward the wire harness 100. The first elastic piece 41 has a flat surface that abuts on the wire harness 100 at the first curved part 41c that is the portion between both ends 41a and 41b in the X direction (see FIG. 17).

The base 3 includes a second elastic piece 42 that is arranged to extend in the X direction, and that abuts on the wire harness 100 from the side opposite to the first elastic piece 41. In consideration of the formability of the mold, a second through-hole 3h is provided in the bottom wall 3a that is the portion of the base 3 that faces the top wall 4a, and the second elastic piece 42 extends from the periphery of the second through-hole 3h.

The second elastic piece 42 has both ends 42a and 42b in the X direction as fixed ends. That is, the second elastic piece 42 is supported at both ends with respect to the base 3. In addition, the second elastic piece 42 has a second curved part 42c having a shape in which the portion between both ends 42a and 42b in the X direction is curved to be convex toward the wire harness 100. The second elastic piece 42 has a flat surface that abuts on the wire harness 100 at the second curved part 42c that is the portion between both ends 42a and 42b in the X direction (see FIG. 17).

Next, the effect of the protector 1D will be described.

In the protector 1D according to the fourth embodiment, the elastic piece includes the first elastic piece 41 that is provided in the cover 4 so as to extend in a direction (X direction) intersecting with the extension direction of the wire harness 100 (Y direction), and that abuts on the wire harness 100. The elastic piece includes the second elastic piece 42 that is provided in the base 3 so as to extend in the direction (X direction) intersecting with the extension direction of the wire harness 100 (Y direction), and that abuts on the wire harness 100 from the side opposite to the first elastic piece 41.

In the protector 1D according to the fourth embodiment, the first elastic piece 41 and the second elastic piece 42 respectively have both ends 41a and 41b and both ends 42a and 42b in the direction (X direction) intersecting with the extension direction of the wire harness 100 (Y direction) as fixed ends. The first elastic piece 41 and the second elastic piece 42 have a shape in which the portion between both ends 41a and 41b and the portion between both ends 42a and 42b in the direction (X direction) intersecting with the extension direction of the wire harness 100 (Y direction) are curved to be convex toward the wire harness 100.

Further, in the protector 1D according to the fourth embodiment, the first elastic piece 41 and the second elastic piece 42 have flat surfaces that abut on the wire harness 100 at the portion between both ends in the direction (X direction) intersecting with the extension direction of the wire harness 100 (Y direction).

By forming the first elastic piece 41 and the second elastic piece 42 in this way, when the cover 4 is mounted on the base 3, the first elastic piece 41 and the second elastic piece 42 are deformed according to the outer diameter of the wire harness 100, thereby making it possible to hold the wire harness 100 using the reaction force.

As described above, as in the first to the third embodiments, the fourth embodiment makes it possible to provide the protector 1D that is advantageous in suppressing the generation of abnormal noise by holding the wire harness 100.

### Fifth Embodiment

Next, a protector 1E according to a fifth embodiment will be described. It should be noted that components that are substantially the same as those of the above protectors are denoted by the same reference numerals, and a description thereof will be omitted.

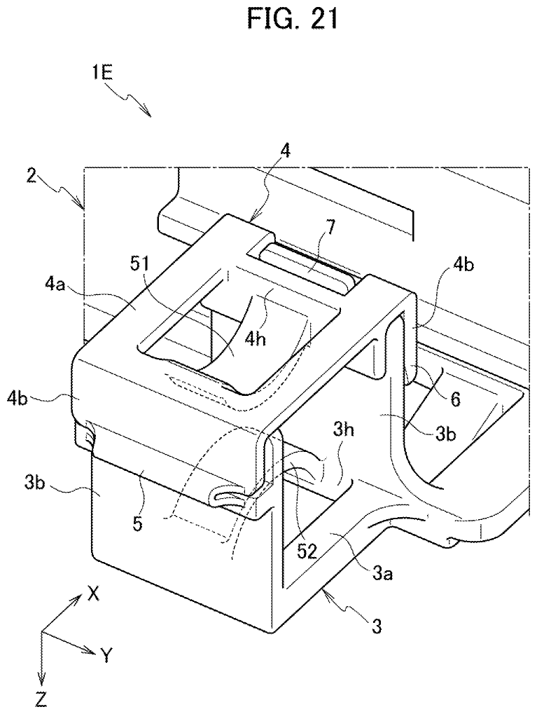

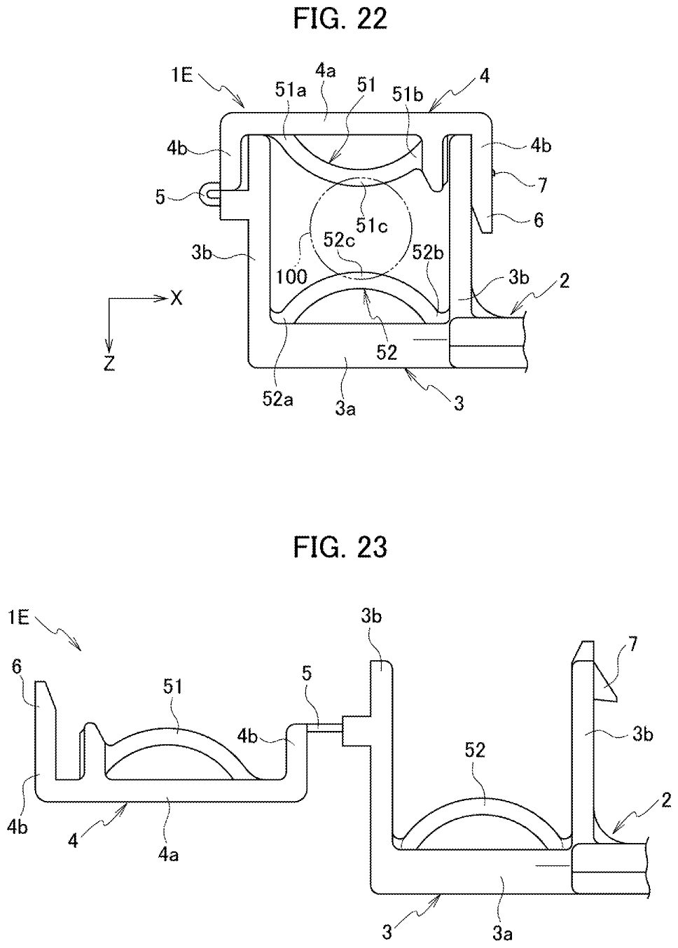

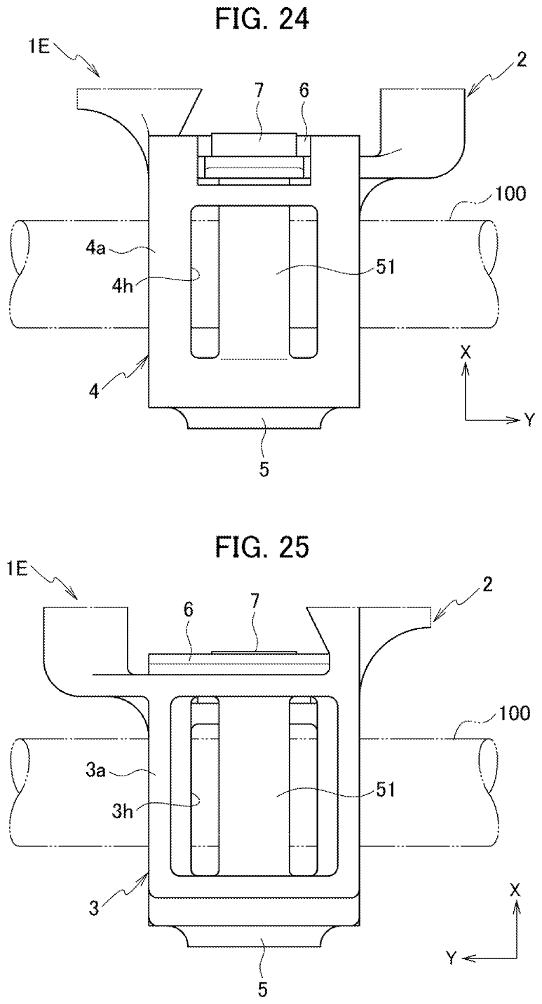

FIG. 21 is a perspective view of the main portion of the protector 1E according to the fifth embodiment. FIG. 22 is a front view of the main portion of the protector 1E according to the fifth embodiment, and FIG. 23 is a front view of the exploded main portion of the protector 1E according to the fifth embodiment. The protector 1E illustrated in FIG. 23 is in a state before the wire harness 100 is held. In addition, FIG. 24 is a plan view of the main portion of the protector 1E according to the fifth embodiment, and FIG. 25 is a bottom view of the main portion of the protector 1E according to the fifth embodiment.

The cover 4 includes a first elastic piece 51 that is arranged to extend in a direction (X direction) intersecting with the extension direction of the wire harness 100 (Y direction), and that abuts on the wire harness 100. In consideration of the formability of the mold, a first through-hole 4h is provided in the top wall 4a that is the portion of the cover 4 that faces the bottom wall 3a, and the first elastic piece 51 extends from the periphery of the first through-hole 4h.

The first elastic piece 51 has both ends 51a and 51b in the X direction as fixed ends. That is, the first elastic piece 51 is supported at both ends with respect to the cover 4. In addition, the first elastic piece 51 has a first curved part 51c having a shape in which the portion between both ends 51a and 51b in the X direction is curved to be convex toward the wire harness 100. The first elastic piece 51 has a curved surface that abuts on the wire harness 100 at the first curved part 51c that is the portion between both ends 51a and 51b in the X direction is (see FIG. 22).

The base 3 includes a second elastic piece 52 that is arranged to extend in the X direction, and that abuts on the wire harness 100 from the side opposite to the first elastic piece 51. In consideration of the formability of the mold, a second through-hole 3h is provided in the bottom wall 3a that is the portion of the base 3 that faces the top wall 4a, and the second elastic piece 52 extends from the periphery of the second through-hole 3h.

The second elastic piece 52 has both ends 52a and 52b in the X direction as fixed ends. That is, the second elastic piece 52 is supported at both ends with respect to the base 3. In addition, the second elastic piece 52 has a second curved part 52c having a shape in which the portion between both ends 52a and 52b in the X direction is curved to be convex toward the wire harness 100. The second elastic piece 52 has a curved surface that abuts on the wire harness 100 at the second curved part 52c that is the portion between both ends 52a and 52b in the X direction (see FIG. 22).

Next, the effect of the protector 1E will be described.

In the protector 1E according to the fifth embodiment, the elastic piece includes the first elastic piece 51 that is provided in the cover 4 so as to extend in a direction (X direction) intersecting with the extension direction of the wire harness 100 (Y direction), and that abuts on the wire harness 100. The elastic piece includes the second elastic piece 52 that is provided in the base 3 so as to extend in the direction (X direction) intersecting with the extension direction of the wire harness 100 (Y direction), and that abuts on the wire harness 100 from the side opposite to the first elastic piece 51.

In the protector 1E according to the fifth embodiment, the first elastic piece 51 and the second elastic piece 52 respectively have both ends 51a and 51b and both ends 52a and 52b in the direction (X direction) intersecting with the extension direction of the wire harness 100 (Y direction) as fixed ends. The first elastic piece 51 and the second elastic piece 52 have a shape in which the portion between both ends 51a and 51b and the portion between both ends 52a and 52b in the direction (X direction) intersecting with the extension direction of the wire harness 100 (Y direction) are curved to be convex toward the wire harness 100.

Further, in the protector 1E according to the fifth embodiment, the first elastic piece 51 and the second elastic piece 52 have curved surfaces that abut on the wire harness 100 at the portion between both ends in the direction (X direction) intersecting with the extension direction of the wire harness 100 (Y direction).

By forming the first elastic piece 51 and the second elastic piece 52 in this way, when the cover 4 is mounted on the base 3, the first elastic piece 51 and the second elastic piece 52 are deformed according to the outer diameter of the wire harness 100, thereby making it possible to hold the wire harness 100 using the reaction force.

As described above, as in the first to the fourth embodiments, the fifth embodiment makes it possible to provide the protector 1E that is advantageous in suppressing the generation of abnormal noise by holding the wire harness 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A protector comprising:
a base that is configured to accommodate a wire harness; and
a cover that is connected to the base to cover the base, wherein
at least one of the base and the cover is provided with an elastic piece that is arranged to extend in a direction intersecting with an extension direction of the wire harness, and that abuts on the wire harness.

2. The protector according to claim 1, wherein
the elastic piece includes:
a first elastic piece that is provided in the cover so as to extend in the intersecting direction, and that abuts on the wire harness; and
a second elastic piece that is provided in the base so as to extend in the intersecting direction, and that abuts on the wire harness from a side opposite to the first elastic piece.

3. The protector according to claim 2, wherein
the first elastic piece and the second elastic piece each have one end as a fixed end and the other end as a free end.

4. The protector according to claim 3, wherein
the first elastic piece has a fixed end arranged on one side in the intersecting direction, and a free end arranged on the other side in the intersecting direction, and
the second elastic piece has a free end arranged on one side in the intersecting direction, and a fixed end arranged on the other side in the intersecting direction.

5. The protector according to claim 3, wherein
the first elastic piece and the second elastic piece each have a fixed end arranged on one side in the intersecting direction, and a free end arranged on the other side in the intersecting direction.

6. The protector according to claim 2, wherein
the first elastic piece and the second elastic piece each have both ends in the intersecting direction as fixed ends, and have a shape in which a portion between both ends in the intersecting direction is curved to be convex toward the wire harness.

7. The protector according to claim 6, wherein
the first elastic piece and the second elastic piece each have a flat surface that abuts on the wire harness at the portion between both ends in the intersecting direction.

8. The protector according to claim 6, wherein
the first elastic piece and the second elastic piece each have a curved surface that abuts on the wire harness at the portion between both ends in the intersecting direction.
